(19) United States
(12) Patent Application Publication
(10) Pub. No.: US 2018/0029345 A1
(43) Pub. Date: Feb. 1, 2018

(54) ROOFING MEMBRANE AND PROCESS FOR PRODUCING THE ROOFING MEMBRANE

(71) Applicant: DSM IP Assets B.V., Heerlen (NL)

(72) Inventors: Pascal Maria Hubert Pierre TIJSSEN, Echt (NL); Caroline MITTERLEHNER, Echt (NL)

(21) Appl. No.: 15/552,045

(22) PCT Filed: Feb. 4, 2016
(86) PCT No.: PCT/EP2016/052383

§ 371 Date: Aug. 18, 2017

(30) Foreign Application Priority Data
Feb. 24, 2015 (EP) 15156372.3

(51) Int. Cl. B32B 27/40

(52) U.S. Cl. CPC B32B 27/40; B32B 7/12

(57) ABSTRACT

A roofing membrane comprising a barrier film that consists of a polymer composition comprising a thermoplastic polyurethane (TPU) and a thermoplastic polyether ester (TPEE).

The invention relates to a roofing membrane and a process for producing the roofing membrane. A roofing membrane and a process for producing the roofing membrane are known from EP-A-1100844.

Roofing membranes are often applied at pitched roofs, below the roof covering, for example below tiles, slates etc. Such a roofing membrane is a barrier for water to penetrate into buildings, for example coming from leakages in the roof covering, formed by melting of fine snow that has been blown through gaps between tiles, or due to water penetration by driving rains. However, since the sheet has an adequate permeability for water vapor (also expressed as moisture vapor transmission rate), humidity that tends to accumulate in buildings is released, keeping the indoor condition dry enough to ensure the good health of people living or working in the buildings and to avoid rot in wooden structures of buildings, for example in wooden beams of the roof construction.

Roofing membranes in general comprise a layer of a fleece and a layer of a barrier film or two layers of fleece and a barrier film, the barrier film being located between the two layers of fleece. The barrier film of the roofing membrane of EP-A-1100844 consists of a polymer composition comprising a copolyether ester.

Advantages of the barrier film of a polymer composition comprising a copolyether ester include that the film may be produced with a low thickness. This counts for both roofing membranes produced by lamination and by extrusion coating. Furthermore the copolyether ester has a good thermal stability, which is important, since the roofing membrane may be subjected to high temperatures, especially if applied below tiles. After application at the roof the sheet is occasionally exposed for several months, up to four month is a period normally accepted by roof builders, to UV radiation by sunlight, before the roof covering is applied. Also after the covering is applied exposure might continue, because of openings in the roof covering, letting rays of sunlight through. A disadvantage of the copolyether ester is the low UV-resistance. This may be solved by the addition of UV stabilizers and/or UV absorbers, as for instance disclosed in EP-A-1100844, but especially the UV stabilizers are costly and there is still need for a further improved UV-resistance.

Furthermore the film of the polymer composition comprising the copolyether ester is slippery. Since the layer of the barrier film of the roofing membrane is often applied facing the outside of the building, the building constructors often have to walk on the film. If the film is slippery this may cause a problem with respect to safety.

It is also possible that the barrier film consists of a polymer composition comprising a thermoplastic polyurethane. Advantages of a thermoplastic polyurethane include the very high level of UV-resistance obtainable with suitable UV stabilizers and/or UV absorbers and the high coefficient of friction of the surface, providing low slipperiness. A large disadvantage of the thermoplastic polyurethane is the low viscosity. Because of the low viscosity it is not possible to produce the barrier film with a low thickness, making the film from a viewpoint of costs unattractive.

Aim of the invention is to provide a roofing membrane that does not show these disadvantages and that is nevertheless cost attractive.

This aim is achieved by providing a roofing membrane comprising a barrier film of a polymer composition comprising a copolyether ester and a thermoplastic polyurethane.

Surprisingly the polymer composition may be extruded into a thin barrier film, even at high extrusion speed, similar to the extrusion of the barrier film of the thermoplastic copolyether ester.

Furthermore the barrier film of the roofing membrane according to the invention shows a very high UV resistance, similar to the UV resistance of the barrier film of the thermoplastic polyurethane.

Furthermore the barrier film of the roofing membrane according to the invention shows a very high temperature resistance, similar to the high temperature resistance of the barrier film of the thermoplastic copolyether ester elastomer.

Finally the roofing membrane is more cost effective, because of the relatively low price of TPU. This while this is not the case for a roofing membrane comprising a barrier film of TPU, because TPU cannot being processed into a barrier film with a low thickness.

The copolyether ester (TPEE) suitably contains hard segments that are built up from repeating units derived from at least one alkylene diol and at least one aromatic dicarboxylic acid or an ester thereof. As alternative to segment, also the term block is being used. The linear or cycloaliphatic alkylene diol contains generally 2-6 C-atoms, preferably 2-4 C-atoms. Examples thereof include ethylene glycol, propylene diol and butylene diol. Preferably propylene diol or butylene diol are used, more preferably 1,4-butylene diol. Examples of suitable aromatic dicarboxylic acids include terephthalic acid, 2,6-naphthalenedicarboxylic acid, 4,4′-biphenyldicarboxylic acid or combinations of these. The advantage thereof is that the resulting polyester is generally semi-crystalline with a melting point of above 150, preferably above 175, and more preferably of above 190° C. The hard segments may optionally further contain a minor amount of units derived from other dicarboxylic acids, for example isophthalic acid, which generally lowers the melting point of the polyester. The amount of other dicarboxylic acids is preferably limited to not more than 10, more preferably not more than 5 mol %, so as to ensure that, among other things, the crystallization behaviour of the copolyether ester is not adversely affected. The hard segment is preferably built up from ethylene terephthalate, propylene terephthalate, and in particular from butylene terephthalate as repeating units. Advantages of these readily available units include favourable crystallisation behaviour and a high melting point, resulting in copolyether esters with good processing properties, excellent thermal and chemical resistance and good puncture resistance.

Suitable aliphatic polyether soft segments in the copolyether ester of component (a) are flexible polyethers that are substantially amorphous and have a glass-transition temperature (T_{g}) of below 0° C. Preferably, the T_{g} is below −20° C., more preferably below −40, and most preferably below 50° C. The molar mass of the segments may vary within a wide range, but preferably the molar mass is chosen between 400 and 6000, more preferably between 500 and 4000, and most preferably between 750 and 3000 g/mol. Suitable aliphatic polyethers include a poly(alkylene oxide)diol derived from an alkylene oxide of 2-6 C-atoms, preferably 2-4 C-atoms, or combinations thereof. Examples include poly(ethylene oxide)diol, poly(tetramethylene oxide)diol or poly(tetrahydrofuran)diol, poly(neopentylene oxide-co-tetramethylene oxide)diol, poly(propylene oxide)diol and ethylene oxide-terminated poly(propylene oxide)diol. High durability of the sheet according to the invention is obtained if the copolyether ester contains as polyether segments polypropylene glycol segments, polyethylene glycol segments and/or polytetrahydrofuran segments. Polytetrahydrofuran segments provide the best durability, polyethylene glycol segmenst provide a combination of high durability and high vapour permeability

The copolyether ester may further contain a compound with two or more functional groups that can react with an acid- or hydroxyl-group, acting as chain extension or chain branching agent, respectively. Examples of suitable chain extension agents include carbonylbislactams, diisocyanates and bisepoxides. Suitable chain branching agents include e.g. trimellitic acid, trimellitic acid anhydride and trimethylol propane. The amount and type of chain extension or branching agent is chosen such that a block copolyester of desirable melt viscosity is obtained. In general, the amount of a chain branching agent will not be higher than 6.0 equivalents per 100 moles of dicarboxylic acids presenting the copolyether ester.

Examples and preparation of copolyether esters are for example described in Handbook of Thermoplastics, ed. O. Olabishi, Chapter 17, Marcel Dekker Inc., New York 1997, ISBN 0-8247-9797-3, in Thermoplastic Elastomers, 2nd Ed, Chapter 8, Carl Hanser Verlag (1996), ISBN 1-56990-205-4, in Encyclopedia of Polymer Science and Engineering, Vol. 12, Wiley & Sons, New York (1988), ISBN 0-471-80944, p. 75-117, and the references cited therein.

Thermoplastic polyurethanes (TPU) may be formed by the reaction between diisocyanates, short chain doils or diamines and long chain diols or diamines. Commonly used as diisocyanates is 4,4′-diphenylmathane diisocyanate (MDI). Short chain diols may be used as chain extenders. Examples of such short chain diols include ethylene glycol, 1,4 butane diol and 1,6-hexanediol. Preferably as long chain diols polyetherdiols or polyetherdiamines are used. As long chain diols preferably the same polyether diols or diamines are used as described above for the copolyether ester. Instead of a diol it is possible to use a corresponding diamine.

Preferably the polymer composition of the barrier film of the roofing membrane according to the invention comprises preferably 10-70 parts by weight (pbw) TPU and 90-30 pbw TPEE, the amounts of TPU and TPEE adding up to 100 pbw. More preferably the polymer composition comprises 20-60 pbw TPU and 80-40 pbw TPEE, the amounts of TPU and TPEE adding up to 100 pbw. Even more preferably the polymer composition comprises 30-50 pbw TPU and 70-50 pbw TPEE, the amounts of TPU and TPEE adding up to 100 pbw.

Preferably the polymer composition consists of the TPU, the TPEE and non-polymeric additives, such as for example colorants, pigments, stabilizers and processing aids.

The roofing membrane according to the invention may contain the barrier film and at one or two surfaces of the film a fleece. As fleece normally a non-woven or needle punched fleece is used.

In one further embodiment the roofing membrane consists of the film of the polymer composition. Such membranes are also referred to as monolithic films. The advantage of a monolithic film is that the film is easy to produce and is yet very flexible at low temperatures, making the film resistant against mechanical stresses caused by winds at low temperatures.

It is possible to extrude a film by blow molding or to extrude a flat film in a first step. In a second step the roofing membrane according to the invention may be formed by adhering the film to the fleece by using a glue.

Preferably a flat film extrusion process is used, wherein the barrier film is extruded and wherein thereafter the barrier film is still in the molten state brought in contact with the fleece, so that after cooling of the film, the film is adhered to the fleece.

The thickness of the barrier film may be up to 200μ, preferably the thickness is between 25 and 150μ, more preferably between 50 and 100μ.

The invention is further explained in the Figure, without being restricted to that.

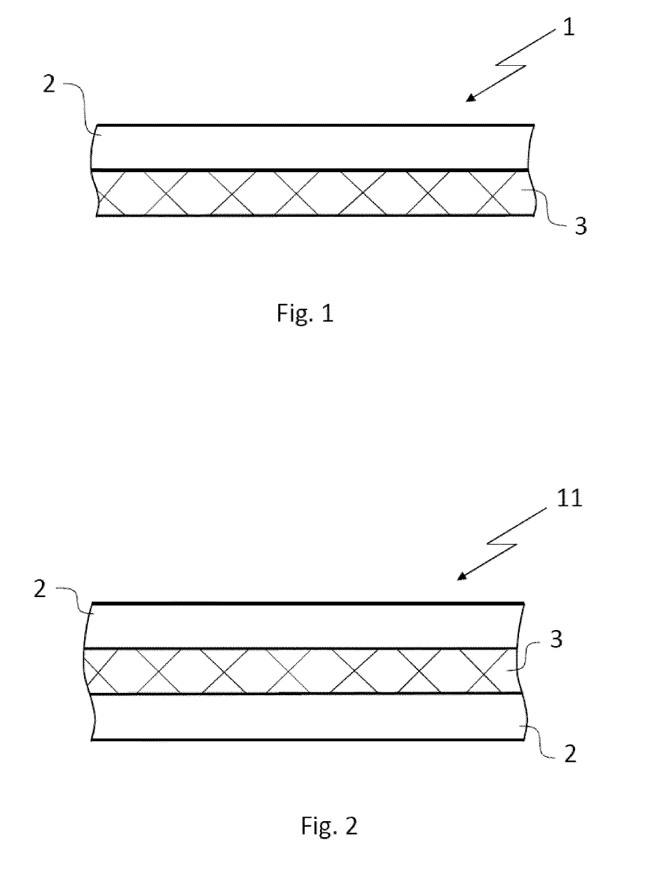

FIG. 1 shows a membrane according to the invention consisting of a barrier film and a fleece.

FIG. 2 shows a membrane according to the invention consisting of a fleece and two barrier films, one at each side of the fleece.

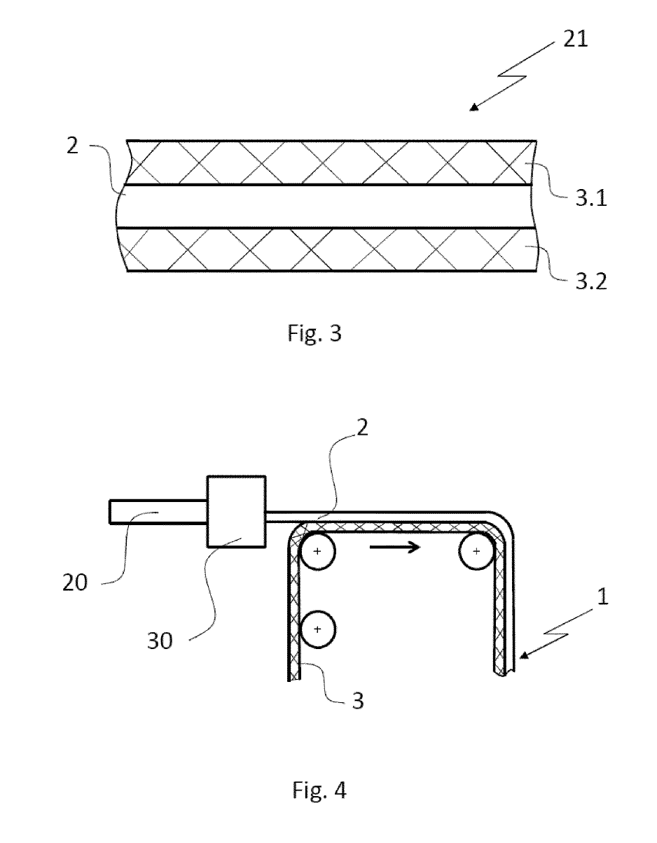

FIG. 3 shows a membrane according to the invention consisting of a barrier film and two fleeces, one at each side of the barrier film.

FIG. 4 shows a co-extrusion line for carrier out the preferred process of the present invention.

FIG. 1 shows a membrane (1) according to the invention consisting of a fleece (3) and a barrier film (2) consisting of a polymer composition comprising a TPU and a TPEE.

FIG. 2 shows a membrane (11) according to the invention consisting a fleece (3) and of two barrier films (2), one at each side of the fleece.

FIG. 3 shows a membrane (21) according to the invention consisting of two fleeces (3.1) and (3.2) and a barrier film (2).

FIG. 4 shows a flat film extrusion line for producing the membrane according to the invention. The extrusion line comprises an extruder (20) for delivering a molten polymer composition comprising the TPU and the TPEE die head (30). The barrier film (2) of the polymer composition is after leaving the die head brought in contact with the fleece (3) so that after cooling down the film adheres to the fleece.

The invention will further be elucidated with reference to the following examples and comparative examples, without being limited hereto

### Materials Used.

EM400: Arnitel® EM400, a copolyether ester delivered by DSM Engineering Plastics.
E2-UV: masterbatch Arnitel® E2-UV, a masterbatch of COPOLYETHER ESTER, comprising UV stabilizers, delivered by DSM Engineering Plastics.
MVT 75AT3: Estane MVT 75AT3 a thermoplastic polyurethane elastomer (TPU) delivered by Lubrizol Advanced Materials.
6-BK-20: masterbatch BLK MB 6-BK-20, a masterbatch of TPU, comprising UV stabilizers, available from Lubrizol Advanced
Fleece: Polypropylene non-woven available from RKW in Gronau

### Preparation of Roofing Membranes.

The roofing membranes were produced at an extrusion coating machine from the company SML (Austria). The extruder was fitted with a barrier screw, melt sieve and a gear pump. The TPEE and TPU resins were dried before use. The TPEE, TPU and masterbatch were dry blended before extrusion, in the amounts as indicated in table 1. The extruder was filled with the before mentioned dry-blend. The melt obtained in the extruder was extruded on top the fleece material. Thereafter the film was cooled down, the film being bonded to the fleece. The structure is further explained in FIG. 1.

Sample compositions of Examples 1&2 and Comparative Examples A&B are listed in table 1. The examples 1&2 are directed to sheets according to the invention, comprising barrier film of a TPEE and a TPU as explained above. Comparative examples A&B are directed to barrier films comprising either TPEE and a masterbatch or TPU and a masterbatch. The preparation of the roofing membranes is the same as for the examples.

TABLE 1
Compositions of examples and comparative
examples according the invention.

| Example | | | 1 | 2 | | |
|---|---|---|---|---|---|---|
| Comparative example | | | | | A | B |
| Polymer composition | EM400 | Wt % | 72 | 52 | | 92 |
| | MVT 75AT3 | Wt % | 20 | 40 | 98 | |
| | E2-UV | Wt % | 8 | 8 | | 8 |
| | 6-BK-20 | Wt % | | | 2 | |

The sample compositions as listed in table 1 are processed at different extrusion speeds. The extruder setting were such that the output of both extruders is equal. Coating thickness was determined by weight. The target layer thickness for all extrusion conditions was 40 grams per square meter. The different extrusion conditions are listed in table 2.

TABLE 2
Extrusion speed versus coating thickness.

| | | Extrusion | Layer | Extrusion | Layer | Extrusion | Layer |
|---|---|---|---|---|---|---|---|
| | Comp. | speed | thickness | speed | thickness | speed | thickness |
| Ex. | Ex. | M/Min | Gram/M2 | M/Min | Gram/M2 | M/Min | Gram/M2 |
| 1 | | 20 | 42 | 60 | 41 | 80 | 42 |
| 2 | | 20 | 38 | 60 | 43 | 80 | 41 |
| | A | 20 | 40 | 60 | NP* | 80 | NP* |
| | B | 20 | 41 | 60 | 40 | 80 | 42 |

*Not Processable

The comparative examples A&B show the difference in processability of the copolyether ester composition compared to the TPU composition. The copolyether ester composition can be produced in thin layers at 80 meters per minute line speed without any problems to provide a 40 grams per square meter film. The TPU composition on the other hand can't be processed at speeds as of 60 meters per minute if a coating thickness of 40 grams per square meter is demanded. Examples 1&2 show that it is possible to increase the line speed of the machine up to 80 meters per minute when an extrusion film out of a composition comprising a copolyether ester and a TPU is used.

1. A roofing membrane comprising a barrier film that consists of a polymer composition comprising a thermoplastic polyurethane (TPU) and a thermoplastic polyether ester (TPEE).

2. Roofing membrane according to claim 1, wherein the polymer composition comprises
10-70 pbw TPU and
90-30 pbw TPEE,
the amounts of TPU and TPEE adding up to 100 pbw.

3. Roofing membrane according to claim 1, wherein the polymer composition comprises
20-60 pbw TPU and
80-40 pbw TPEE,
the amounts of TPU and TPEE adding up to 100 pbw.

4. Roofing membrane according to claim 1, wherein the polymer composition comprises 30-50 pbw TPU and
70-50 pbw TPEE,
the amounts of TPU and TPEE adding up to 100 pbw.

5. Roofing membrane according to claim 1, wherein the polymer composition consists of the TPU, the TPEE and non-polymeric additives.
